(19) United States
(12) Patent Application Publication
(10) Pub. No.: US 2026/0116085 A1
(43) Pub. Date: Apr. 30, 2026

(54) MASKING BASED ON INTERLEAVING ZONES

(71) Applicant: Hewlett-Packard Development Company, L.P., Spring, TX (US)

(72) Inventors: Hector GOMEZ MINANO, Sant Cugat del Valles (ES); Utpal Kumar SARKAR, Sant Cugat del Valles (ES); Pau COSTAL FORNELLS, Sant Cugat del Valles (ES); Peter MOROVIC, Sant Cugat del Valles (ES); Sergio ETCHEBEHERE JUAN, Sant Cugat del Valles (ES); Jan MOROVIC, Reading (GB)

(73) Assignee: Hewlett-Packard Development Company, L.P., Spring, TX (US)

(21) Appl. No.: 18/932,046

(22) Filed: Oct. 30, 2024

(51) Int. Cl. B41J 2/21; G06K 15/02

(52) U.S. Cl. CPC B41J 2/2132; G06K 15/1881; G06K 2215/101

(57) ABSTRACT

A process includes defining top and bottom interleaving zones of a print swath, generating a top interleaving mask corresponding to the top interleaving zone based on an objective drop density for the top interleaving mask, and drop locations provided by a print mask, generating a bottom interleaving mask corresponding to the bottom interleaving zone based on the top interleaving mask, selecting a subset of drop locations provided by the print mask by applying the top and bottom interleaving masks to the print mask, and causing colorant to be deposited to a substrate according to the selected subset of drop locations.

### BACKGROUND

In printing, halftoning is a process which indicates how a discrete number of printing materials are distributed spatially to generate a continuous-tone image. For example, drops of different colorants may be deposited to a substrate according to a halftone pattern to produce the appearance of a continuous-tone image. In multi-pass print modes, for a particular halftone pattern, the manner in which drops of a colorant are deposited to a substrate according to print masks impacts image quality.

### BRIEF DESCRIPTION OF THE DRAWINGS

Examples will now be described, by way of non-limiting example, with reference to the accompanying drawings, in which:

FIG. 1 is an illustration of an example printer device according to an example;

FIG. 2 is a block diagram of a printing pipeline of a printer controller that generates print data according to some examples;

FIGS. 3A-3B illustrate examples of generating a halftone pattern according to some examples;

FIGS. 4A-4C illustrates an example of defining interleaving zones for multi-pass printing according to some examples;

FIG. 5 illustrates examples of interleaving masks and the result of applying interleaving masks to a print mask according to some examples;

FIG. 6 is a flowchart illustrating causing printing to be performed according to an example;

FIG. 7 is a block diagram illustrating a computer program product according to an example;

FIG. 8 is a block diagram illustrating an example fluid delivery apparatus according to an example; and

FIG. 9 is a block diagram illustrating a hardware apparatus including a semiconductor package according to an example.

### DETAILED DESCRIPTION

A printer may operate according to a multi-pass print mode. In a multi-pass print mode, printing occurs in a bidirectional manner in that drops of a colorant may be deposited to an area of a substrate as a printhead travels in a forward pass direction (e.g., left-to-right) and also as the printhead travels in a backward or reverse pass direction (e.g., right-to-left). A colorant may be a dye, a pigment, an ink, or a combination of these materials. A substrate, which may be referred to as print media (or a print medium), may include various types of paper, including matt and gloss, cardboard, textiles, plastics and other materials, in various formats, e.g., discrete sheets or continuous rolls. The manner in which colorants in a halftone pattern are deposited to a substrate according to passes may be referred to as masking and/or applying a print mask (or print masks). That is, a print mask may be used to control a printing device to deposit colorants to a substrate.

Halftone patterns and corresponding print masks impact the quality of a printed image. For example, halftone patterns may be generated such that undesirable drop density distribution patterns, which may negatively impact the image quality, are avoided. For example, a halftone pattern having a relative high density of drops in an area results in a non-uniform cluster of drops and a halftone pattern having a relative low density of drops in an area results in a relative empty area (which may be referred to as a voids). The density of drops in an area may be referred to as a local density. Further, print masks may be generated such that image artifacts due to undesirable mixing of liquid colorants are mitigated. For example, print masks may be generated such that colorants are deposited in a manner where one layer of a colorant is sufficiently dry before a next layer of colorant is deposited. That is, colorant coalescence (e.g., how inks interact before fully drying on a substrate) impact the print quality in terms of the appearance of grain. In some cases, print quality may be improved if drops of particular colorants within an area are deposited during the same pass or during different passes.

Further, for multi-pass printing, halftone patterns and a corresponding generated print mask may be susceptible to artifacts due to media advance errors. Media advance errors occur if a substrate is advanced more or less than expected. That is, after colorant is deposited to a substrate according to a number of passes, the substrate is expected to be advanced a set distance, such that a nozzle row of a printhead is at an expected position for printing according to a subsequent pass (or round of passes). If the substrate is advanced more or less than expected, line banding may occur.

According to the techniques herein, in one example, print masks for a multi-pass pattern may be generated such that the generated print masks have variable dense areas according to a particular profile. For example, variable dense areas may be based on a minimum density of drops occurring at a first row (e.g., a top row) and a maximum density of drops occurring after a certain number of rows. In one example, a way to specify these profiles is to generate masks, which may be referred to as interleaving masks. Interleaving masks may be applied to a print mask to generate a print mask having variable dense areas. In some cases, interleaving masks may effectively generate a print mask by selecting a certain subset of the original firing locations. Using interleaving masks may minimize artifacts due to media advance errors, and may further reduce artifacts due to other errors. Thus, according to the techniques described herein, interleaving masks may be generated and applied to print masks in order to improve print quality and mitigate artifacts, including artifacts due to media advance errors.

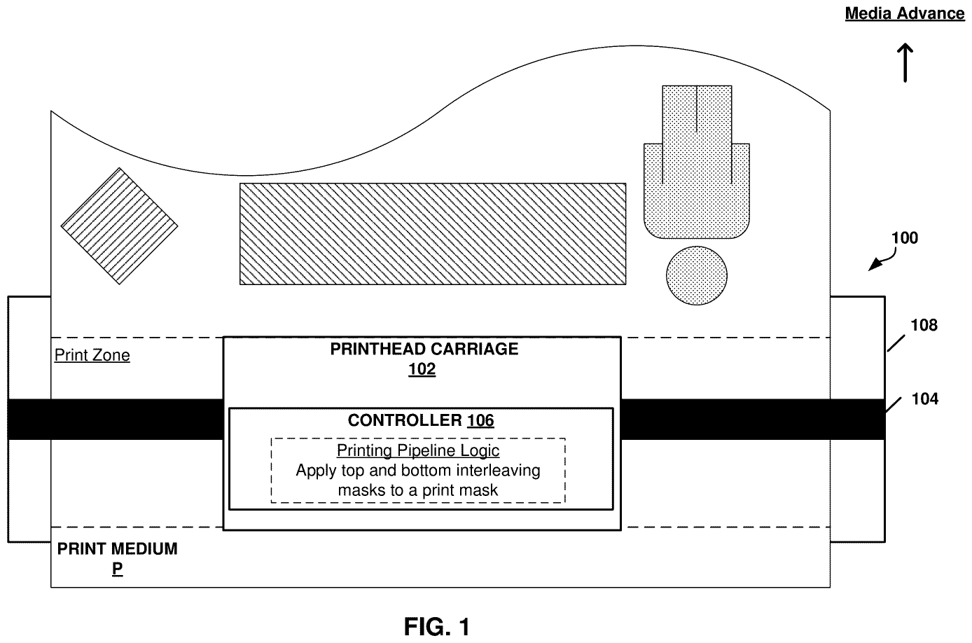

FIG. 1 is an illustration of a printer device 100 according to an example. In the example illustrated in FIG. 1, printer device 100 comprises printhead carriage 102, printhead support structure 104, controller 106, and print medium support assembly 108. Printhead carriage 102 is moveable to traverse the width of print media. It should be noted that in other examples, a printhead carriage may form part of a page wide array printer and include printheads which extend across the width of a print medium P. In the example illustrated in FIG. 1, printhead carriage 102 is supported by printhead support structure 104 such that print medium P may advance underneath printhead carriage 102 in a media advance direction. In the example illustrated in FIG. 1, print medium is supported in a print zone by a print medium support assembly 110. Print medium support assembly 108 may apply a vacuum to adhere a portion of the print medium to print medium support assembly 108 while printing fluid is being deposited. It should be noted that for ease of illustration, printhead support structure 104 and print medium support assembly 108 are represented using simplified structures. The techniques described herein are equally applicable to various physical printer configurations.

Printhead carriage 102 may include a plurality of printheads, where a printhead comprises a die forming a plurality of nozzles. The nozzles may be aligned in columns along a length of a printhead. For example, printhead carriage 102 may comprise a plurality of ink-jet printheads. A printing fluid or agent, including, for example, colorants, such as ink (e.g., water based latex ink), or a modelling agent, may be ejected through the nozzles of the printhead. In this manner, printheads included in printhead carriage 102 may deposit printing fluid onto print medium P while print medium P is in a print zone, thereby printing an image corresponding to a print job. It should be noted that in other examples, a printhead may include a thermal or piezo-electric printhead. It should be noted that ink is used herein as an example, and in other examples, other printing fluids and agents may alternatively be deposited.

Printhead carriage 102 may include a plurality of printheads arranged in staggered rows. It should be noted that in some cases printheads may be referred to as pens. As described above, a printhead comprises a die forming a plurality of nozzles. A die, which may also be referred to as a printhead die, may include an integrated circuit structure formed on a silicon substrate. In some examples, dies may be embedded in monolithic moldings. A printhead architecture may define a number of dies per printhead, a number of columns of nozzles per die, and a number of nozzles per column. For example, six dies may be located in a single printhead, each die may include four columns of nozzles, and each column of nozzles may include hundreds (or thousands) of nozzles. In some examples, a set of columns of nozzles is associated with a different color, such as cyan, magenta, yellow and black (CMYK). It should be noted that in some cases, a set of columns of nozzles may be referred to as a trench or slot. For example, a printing device capable of printing at 1200 dots per inch (DPI) may have 1200 nozzles per inch (e.g., per inch length or per square inch) arranged or formed in its die or dies.

A print swath is an area on a print medium where colorant may be deposited during a pass. For example, during a pass the number of rows that may be printed may be 3100. In this case, an indication of 0 may be provided for the top row of nozzles and an indication of 3099 is indicated for the bottom row of nozzles. In other examples, depending on a particular print head configuration, the number of rows that may be printed may be more or less than 3100. In multi-pass printing, the print medium may be advanced according to a repeating pattern. For example, a pattern may include printing during a forward pass, not advancing the print medium, printing during a reverse pass, and advancing the print medium the entire length of the print swath (e.g., 3100 rows). In other examples, the print medium may be partially advanced during passes. In multi-pass printing, there may be numerous ways in which a print medium is advanced for a set of passes. In some cases, a multi-pass pattern may be susceptible to artifacts due to media advance errors. That is, for example, after a pass, if the print medium is advanced more than expected, a blank line may appear on the print medium.

Referring again to FIG. 1, it should be noted that in FIG. 1, controller 106 is illustrated as being located on printhead carriage 102. Such an illustration is for the sake of illustrative purposes. Controller 106 may also be located at various locations within or in proximity to printer device 100 or may be physically independent of printer device 100. For example, controller 106 may comprise a computer system that is electronically coupled or otherwise in communication (e.g., wirelessly) with printer device 100. Controller 106 may include a memory and/or be electronically coupled to a memory (not shown in FIG. 1). A memory may comprise volatile and/or non-volatile memory. The volatile memory may comprise any form of Random Access Memory (RAM) and the non-volatile memory may comprise solid-state memory, magnetic storage devices, and/or Read Only Memory (ROM), amongst others. Instructions stored in memory may be loaded and executed by a processor of controller 106 to effect the functionality described herein.

Controller 106 may receive print job commands and/or data corresponding to a print job (e.g., image data) from a print job source. A print job source may include a computer or any other source of print jobs. Controller 106 may generate print data such that a print job is executed. That is, controller 106 may cause colorant to be deposited to a substrate. In some examples, controller 106 may derive and/or reproduce a print mask from received data. In some examples, the received data itself may already correspond to a print mask. In other examples, a print mask may be dynamically generated during printing of a print job. Further, a print mask may also be stored from the outset in a memory and controller 106 may then dynamically access the print mask during execution of a print job. Further, controller 106 may include printing pipeline logic to apply top and bottom interleaving masks to a print mask, as described in further detail below.

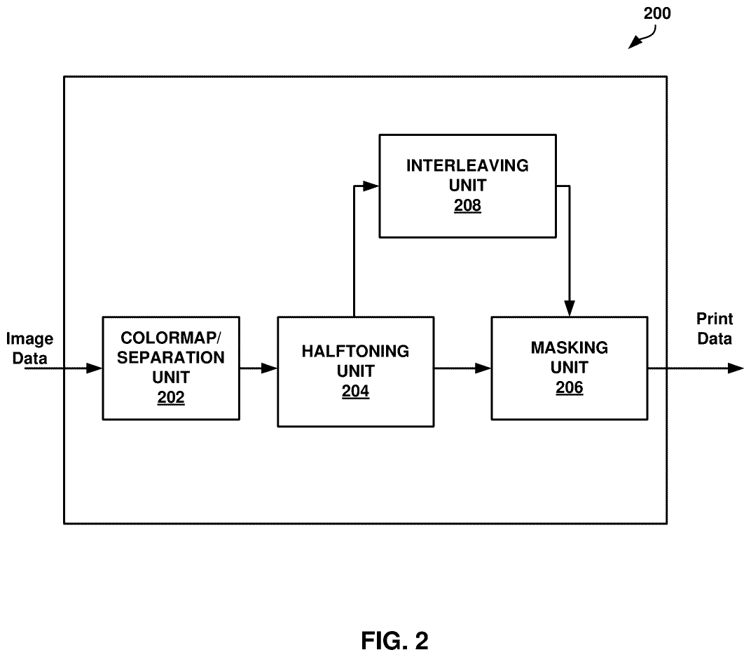

FIG. 2 is a block diagram of a printing pipeline of a printer controller that generates print data according to example techniques described herein. Controller 200 is an example of a controller that may be utilized with various printing systems (e.g., an ink-jet or a laser printer), including, for example, printer device 100. In some cases, the printing pipeline of controller 200 may be referred to as a printing or print engine. As illustrated in FIG. 2, the printing pipeline of controller 200 includes colormap/separation unit 202, halftoning unit 204, masking unit 206, and interleaving unit 208. It should be noted that although example controller 200 is illustrated as having distinct functional blocks, such an illustration is for descriptive purposes and does not limit controller 200 and/or sub-components thereof to a particular architecture. Functions of controller 200 may be realized using any combination of physical and logical implementations. That is, a unit can refer to a hardware processing circuit, which can include any or some combination of a microprocessor, a core of a multi-core microprocessor, a microcontroller, a programmable integrated circuit, a programmable gate array, or another hardware processing circuit. Alternatively, a unit can refer to a combination of a hardware processing circuit and machine-readable instructions executable on the hardware processing circuit or machine-readable instructions.

As illustrated in FIG. 2, the printing pipeline receives image data and generates print data. Print data may be used to control printing of an image to a substrate. In the example of FIG. 2, colormap/separation unit 202 receives input image data and generates a color separation. Input image data may define an image to be printed. For example, input image data may define an image using a number of pixels each of which are associated with a color value in a color space. For example, an image may be represented using a Red, Green, Blue (RGB) color space, where the color of each pixel of the image is represented with respective 8-bit values in the range between 0 and 255 for each of RGB. In other examples, different color spaces and/or bit-depths may be used. A color separation process converts (or separates) image data to corresponding colorants of a printer. A color separation process determines how colorimetric tristimulus values defined according to a color space are represented on the substrate according to corresponding colorants. For example, a printer may be able to deposit cyan, magenta, yellow and black (CMYK) colorants (e.g., ink or toner) to a substrate and a color separation process may be used to convert a color indicated by colorimetric tristimulus values (e.g., RGB values) to colorant values (e.g., CMYK). Thus, a color separation generated by colormap/separation unit 202 provides an indication of the relative amount of each colorant corresponding a location of a substrate.

In some examples, an indication of the relative amount of each colorant corresponding to a location of a substrate may be specified according to area coverage spaces, such as, for example, the Neugebauer Primary area coverage (NPac). According to NPac, an NPac vector represents a statistical distribution of Neugebauer Primaries (NPs) over an area. The set of NPs may depend on an operating configuration of a device, such as a set of available colorants. For example, if a bi-level (i.e. two drop states: “drop” or “no drop”) printing device uses CMY printing fluids there can be eight NPs or output states. These NPs relate to the following: C, M, Y, CM, CY, MY, CMY, and W (white or blank (b) indicating an absence of printing fluid). An NPac vector may define a probability distribution for each NP in a set over a coverage area. For example, an NPac vector may provide that 80% of the coverage area is blank, 10% of the coverage area is covered by the Y NP (e.g., 1 drop of yellow) and 10% of the coverage area is covered by the CM NP (e.g., 1 drop of cyan and 1 additive drop of magenta). Thus, according to this example, the NPac vector provides that for a coverage area of 128×128 pixels (where pixels, in this case correspond to addressable locations of a substrate where a drop of colorant may be deposited) 13,108 of the 16,384 pixels are expected to be blank, 1 drop of yellow is expected to be deposited to 1,638 pixels of the 16,384 pixels, and 1 drop of cyan and 1 drop of magenta are expected to be additively deposited to 1,638 pixels of the 16,384 pixels.

Referring again to FIG. 2, halftoning unit 204 receives color separation data and performs a halftoning process (or halftone process) which indicates how to represent color separation data using a discrete pattern of deposited printing fluid dots. A halftone process may provide how a color separation value is represented on a coverage area of a substrate. For example, with respect to the example described above, a halftone process may provide which locations of the 128×128 coverage area are blank, which locations have 1 drop of yellow and which locations have 1 drop of cyan and 1 additive drop of magenta.

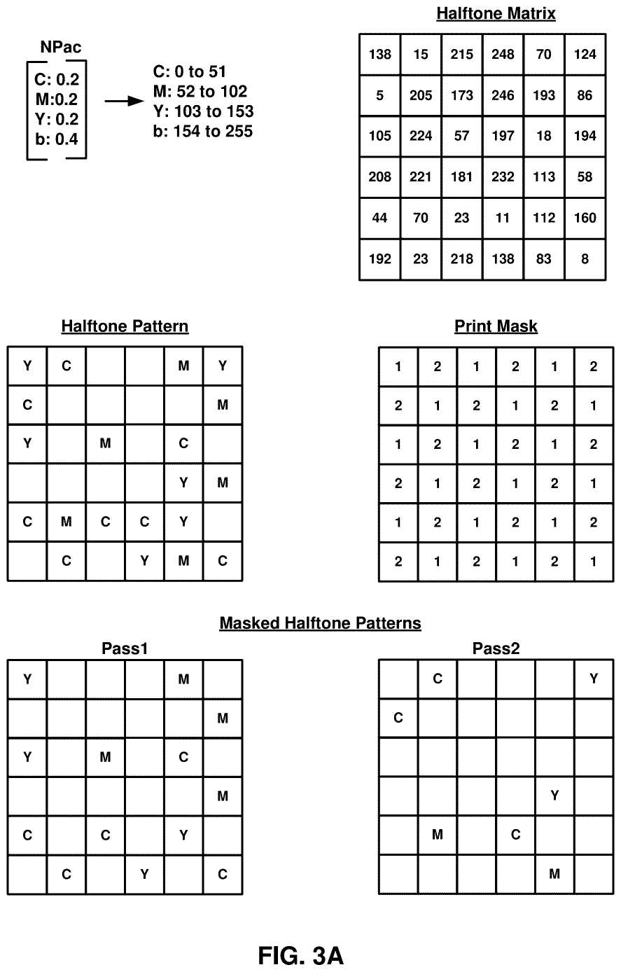

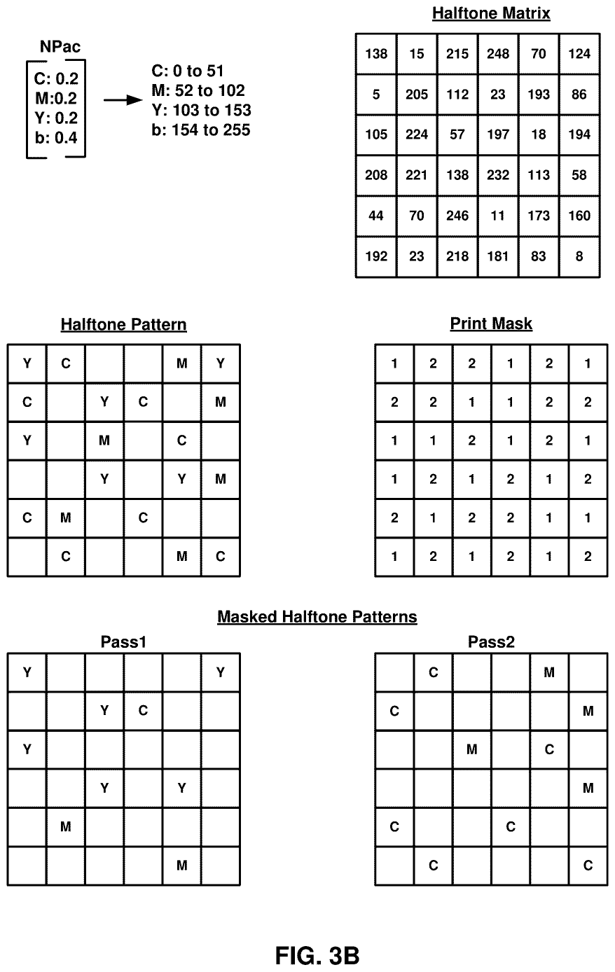

In one example, a halftoning process may utilize a halftone matrix. FIGS. 3A-3B illustrate examples of utilizing a halftone matrix. In each of FIGS. 3A-3B, the following NPac vector is provided for a coverage area [C: 0.2, M: 0.2, Y: 0.2, b: 0.4]. That is, this NPac vector provides cyan is expected to be deposited to 20% of the coverage area, magenta is expected to be deposited to 20% of the coverage area, yellow is expected to be deposited to 20% of the coverage area, and 40% of the coverage area is expected to be blank.

In the example of FIGS. 3A-3B, for purposes of generating a halftone pattern according to a halftone matrix, the probabilities provided by the NPac vector are represented by assigning values in the range 0 to 255 to each of the NPs (i.e., values 0 to 51 corresponds to C, values 52 to 102 corresponds to M, values 103 to 153 corresponds to Y, and values 154 to 255 correspond to b). Each location of the halftone matrix has a value in the range of 0 to 255. As such, the halftone pattern specifies an NP for a location and a halftone pattern is generated according to the NPac vector and the halftone matrix. There may be various ways to represent the probabilities provided by an NPac vector in a halftone matrix. For example, a range greater than 0 to 255 may be used, e.g., 0 to 1023, which corresponds to a bit depth of 10.

There may be various ways in which a halftone matrix is generated. A halftoning process may generate a halftone matrix and/or select a stored halftone matrix. In the example illustrated in FIG. 3A, each cell in the halftone matrix is randomly assigned a value of 0 to 255. In this manner, the coverage area is expected to have the distribution provided by the NPac vector and is expected to have a uniform spatial distribution of NPs. Generating a uniform spatial distribution of NPs may be considered a desirable attribute of a halftoning process. That is, it may be considered undesirable if a particular NP is clustered in an area of the coverage area. For example, if all of the blank space was localized to a particular region of the coverage area, visible artifacts may appear.

Generating a halftone pattern by uniformly distributing random numbers is one example of how a uniform spatial distribution of NPs may be achieved. However, there are various ways in which a halftone matrix may be generated to provide a uniform or otherwise desirable spatial distribution of NPs. For example, a halftone matrix may correspond to a blue noise halftone matrix or a green noise halftone matrix, or may utilize another type of noise. In the example illustrated in FIG. 3B, similar to the example illustrated in FIG. 3A, each cell in the halftone matrix is randomly assigned a value of 0 to 255, however in FIG. 3B, the spatial distribution of the randomly assigned values is adjusted (e.g., according to a distribution function) in a manner which may result in a more desirable halftone pattern. It should be noted that the example halftoning process illustrated in FIGS. 3A-3B the halftone pattern depends on a single matrix. As described above, NPs may be composed of multiple additive drops of colorant (e.g., CM) and a halftone matrix may include NP values corresponding to NPs having multiple additive drops. In this case, in one example, a halftone pattern may include a single matrix, where multiple drops of colorant are allocated to a cell. In other examples, a halftone pattern may include multiple matrices.

As described above, print masks may be generated and used to control a printing device to deposit colorants to a substrate. Referring to FIG. 2, masking unit 206 may generate print masks. That is, for example, masking unit 206 may receive print masks, select stored print masks, and/or generate print masks based on data received from halftoning unit 204 and/or interleaving unit 208. For example, as described in further detail below masking unit 206 may modify a print mask based on interleaving masks generated and/or selected by interleaving unit 208 and the resulting print data may cause a printing device to deposit colorant to a substrate according to the modified print mask.

As described above, a print mask indicates how colorant is deposited to a substrate. For example, in a multi-pass print system, a print mask indicates the pass which a drop of a colorant is to be deposited to a location in a coverage area. For example, in the examples illustrated in FIGS. 3A-3B, each location of the print mask includes a value of 1 or 2, which indicates the pass (e.g., (1) forward pass or (2) reverse pass) which colorant is to be deposited to the substrate. Thus, in the examples FIGS. 3A-3B, the print mask indicates which pass the drop indicated by the halftone pattern is deposited. That is, superimposing (or tiling) the halftone pattern with print mask indicates a pass which a colorant in a halftone pattern is deposited. In FIG. 3A-3B, the masked halftone patterns are illustrated, that is, for a first pass (Pass1) and a second pass (Pass2) locations of colorants to be deposited are indicated. It should be noted that in the example illustrated in FIGS. 3A-3B, a single print mask is used for all of the colorants. In other examples, different masks may be used for each colorant.

As described above, halftone patterns and print masks impact the quality of a printed image. As illustrated, the print mask illustrated in FIG. 3A, alternates between the first pass and the second pass according to adjacent spatial locations. Such a print mask, which may correspond to a selected stored print mask, does not account for the halftone pattern, which may impact print quality. For example, the masked halftone patterns in FIG. 3A, may have an appearance of grain which impacts the print quality. FIG. 3B illustrates an example where the print mask may be considered to be optimized compared to the print mask illustrated in FIG. 3A. That is, FIG. 3B provides an example of a print mask which may be based on decisions of how to allocate halftone pixels amongst passes in order to achieve certain aims. For example, the print mask in FIG. 3B may be designed to improve grain consistency or other image quality characteristics. In this manner, masking unit 206 may generate and/or select a print mask to allocate halftone pixels amongst passes in order to achieve certain aims.

In one example, masking unit 206 may generate print masks based on a density metric corresponding to a halftone matrix. That is, in one example, for each defined halftone level, masking unit 206 may identify pixels of the halftone matrix having a halftone level. For example, in the example illustrated in FIGS. 3A-3B the halftone matrix values corresponding to each of Y, C, M and b may be halftone levels. Masking unit 206 may randomly iterate through the identified pixels and calculate a density metric value for these pixels for each pass. A density metric value indicates a relative density of an area. In one example, the density metric is calculated according to:

$$Density Metric = ep ( - {x}^{2} / 2 {s}^{2} )$$

$$Where : ep = exponent$$

$$x = distance to already allocated pixel$$

$$s = 1 / sqrt ( rho ) / 4 , where rho = density$$

The density metric may be calculated over all of the already allocated pixels, although in practice it can be reduced to a small cutoff distance. In one example, a window of a predetermined size may be allocated around the pixel under consideration and the number of already allocated pixels (with a drop of colorant) which belong to the current halftone range of levels and the current pass are determined. The already allocated pixels are effectively weighted based on distance x, with the density metric value slowly falling by distance x, then falling very quickly to zero. However, other density metric calculations may alternatively be used. In one example, masking unit 206 may allocate the current identified pixel to the pass with the lowest density metric. After all of the halftone pixels for the current halftone value have been allocated, the next halftone level (or range of halftone levels) is considered. Density metric values may be determined for identified pixels in the next halftone level and may be allocated to one of the passes based on this. It should be noted that the value of the density metric will depend on the distance to already allocated halftone pixels from halftone levels as well as any already allocated at the current halftone level.

In this manner, the allocation of halftone pixels for each halftone level to each pass may be more evenly distributed, and in general, the completed mask for each pass may have a more random, but uniform distribution. That is, by allocating the drops in each pass using drop density in each pass, an improved distribution of drops can be generated for each pass. In some examples, the masks can be optimized for other properties using an appropriate density metric. For example, where firing frequency is considered, distances between drops fired in the same row could be optimized. Further, some clustering of drops may be desirable in some circumstances.

As described above, for multi-pass printing, halftone patterns and a corresponding generated print mask may be susceptible to artifacts due to media advance errors. In some cases, print masks based on a density metric corresponding to a halftone matrix may not be robust enough to mitigate against media advance errors. In one example, according to the techniques herein, print masks for a multi-pass pattern may be generated such that the generated print masks have variable dense areas according to a particular profile.

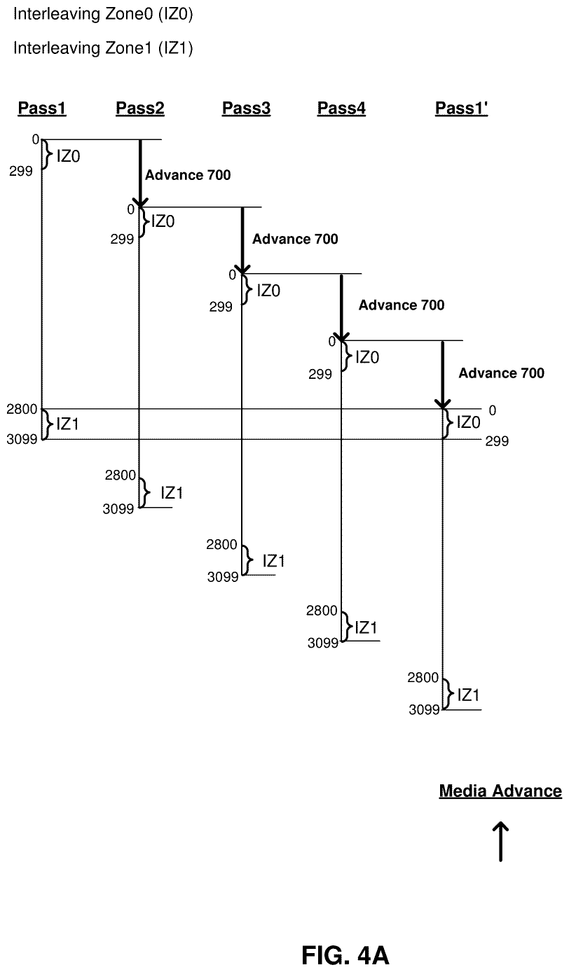

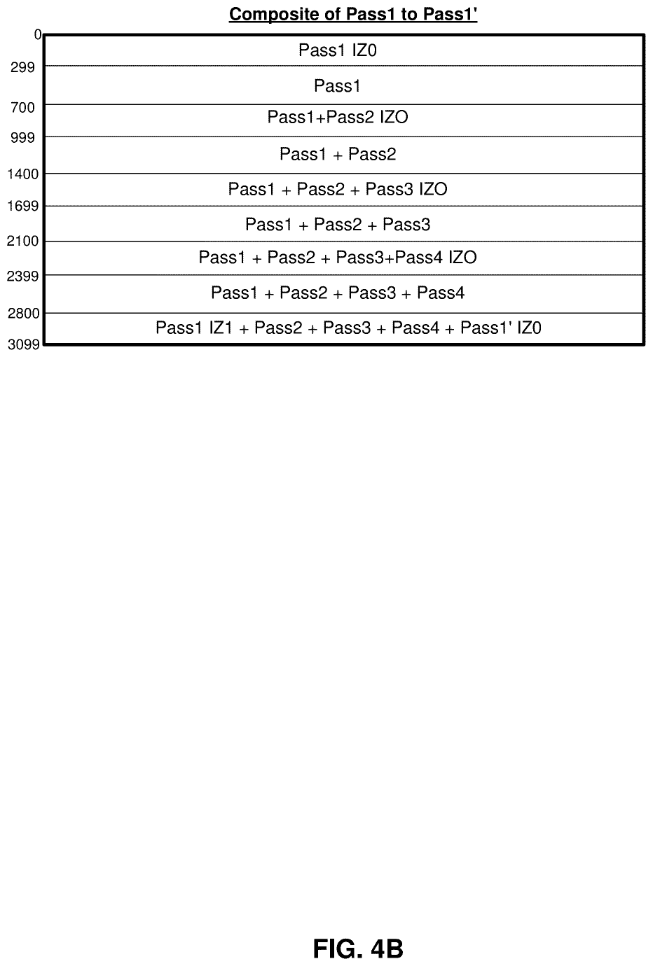

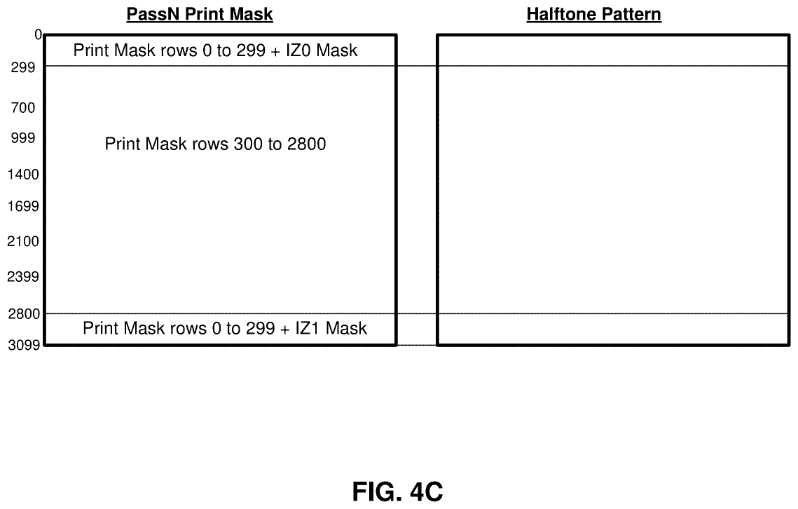

Referring again to FIG. 2, interleaving unit 208 may generate and/or select interleaving masks. That is, in some examples, interleaving unit 208 may generate an interleaving mask according to techniques described herein and in some examples, interleaving unit 208 may select a stored interleaving generated according to techniques described herein. Interleaving masks may be applied to a print mask. As described above, in multi-pass printing there may be numerous ways in which a print medium is advanced for a set of passes. Interleaving unit 208 may generate and/or select interleaving masks corresponding to interleaving zones within a print swath of a pass. FIGS. 3A-3C illustrate an example where interleaving zones are defined for a four pass pattern. In the example illustrated in FIGS. 3A-3C, a print swath is 3100 nozzles rows. In the example of FIGS. 3A-3B, after each pass, the media is advanced 700 nozzles. Further, the top 300 rows of nozzles (i.e., nozzles 0 to 299) are designated as interleaving zone 0, which may be referred to as a top interleaving zone and the bottom 300 rows of nozzles (i.e., nozzles 2799 to 3099) are designated as interleaving zone 1, which may be referred to as a bottom interleaving zone. Thus, the example of FIGS. 3A-3B, the top and bottom interleaving zones cover approximately 20% of the print swath. It should be noted that the number of rows in an interleaving zone may vary. For example, an interleaving zone may include a relatively small number of rows, e.g., 10-30 rows or a number of rows up to approximately a quarter or more of a print swath, e.g., 600 to 1100 rows. It should be noted that FIG. 4A illustrates the advancement of a printhead relative to the media advance direction. That is, because the media is illustrated as moving up with respect to a printing device, the printhead moves down relative to the print medium.

As illustrated in FIG. 4A, after 4 passes, interleaving zone 1 of the first pass of the pattern (Pass1) is overlapped with the first pass of the repeated pattern (Pass1′). FIG. 4B illustrates the composite printing result for each of the passes and interleaving zones illustrated in FIG. 4A. That is, as illustrated in FIG. 4B, colorant is deposited to rows 0 to 299 according to the interleaving zone 0 of Pass1, colorant is deposited to rows 300 to 700 according to Pass1 without an interleaving zone (Pass1), colorant is deposited to rows 700 to 999 according Pass1 and interleaving zone 0 of Pass2, and so on. As illustrated in FIG. 4B, interleaving zone 1 of Pass1 overlaps with interleaving zone 0 of Pass1′. Thus, the result on printing to a substrate is based on colorants being deposited according to a combination of passes in an area.

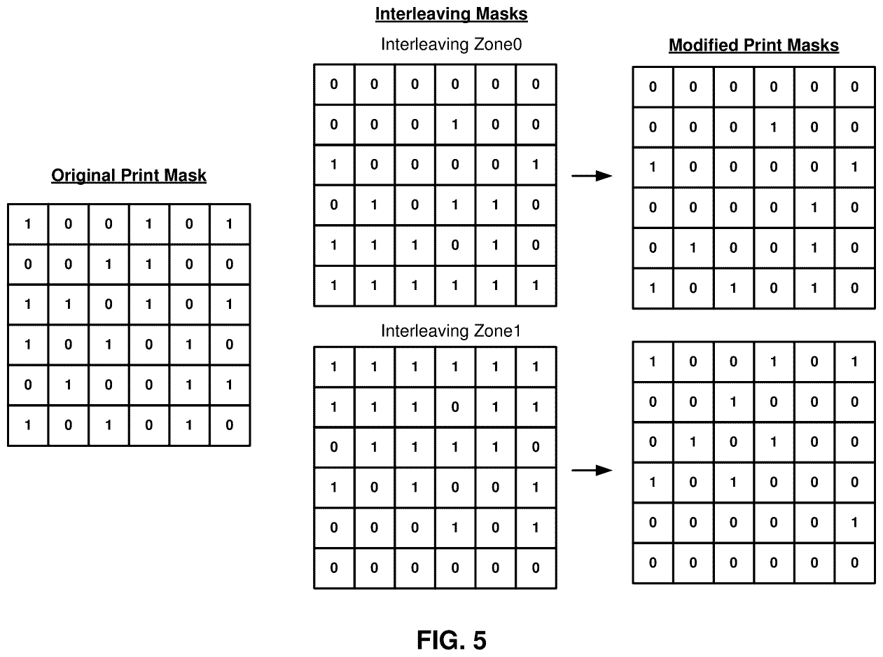

FIG. 4C further illustrates a print mask according to an single pass (PassN) and a corresponding halftone pattern according to the example illustrated in FIG. 4A. Referring to the example illustrated in FIG. 5, a print mask corresponding to a single pass may be represented as 0's and 1's, where a 1 indicates drop(s) of colorant is/are deposited during the pass, and a 0 indicates drops of colorant are not fired during the pass. As described above, masking unit 206 may generate print masks based on a density metric corresponding to a halftone matrix and superimposing the halftone pattern with a print mask indicates how a colorant in a halftone pattern is deposited according to a pass. Further, according to the techniques herein, interleaving masks may be applied to a generated print mask. FIG. 4C illustrates an example of a resulting print mask with interleaving masks applied to the print mask. FIG. 4C further illustrates a corresponding halftone pattern aligned with the resulting print mask.

In the example illustrated in FIG. 4C, for a halftone pattern having 3100 rows, a portion of a resulting print mask corresponding to a pass may include a first region (i.e., rows 0 to 299) which includes the rows 0 to 299 of an original print mask (e.g., generated according to, for example, a density metric) with an interleaving zone 0 mask applied, a second region (i.e., rows 300 to 2799) which includes the corresponding rows of an original rows print mask, and a third region which repeats rows 0 to 299 of an original print mask with an interleaving mask 1 applied. Thus, in the example of FIG. 4C, the central rows are printed according to an original print mask and the top and bottom rows included in respective interleaving zones are modified from the original print mask according to interleaving masks.

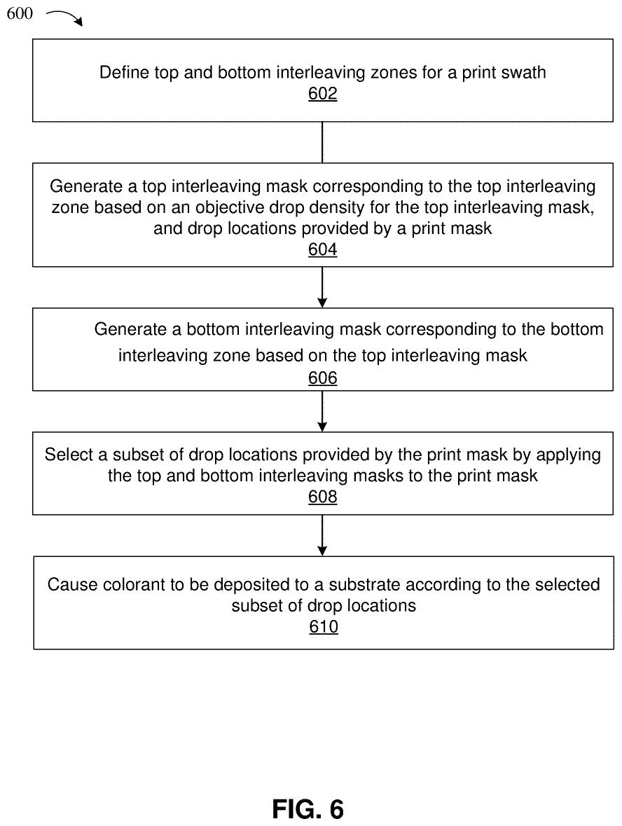

Applying an interleaving mask to a generated print mask, according to the example illustrated in FIG. 6C, allows variable dense areas at the top and the bottom of the print swath to be generated. An interleaving mask may include a mask having values of 1 and 0, where a value of 1 indicates that a drop of colorant is to be deposited and a value of 0 indicates that a drop of colorant is not to be deposited. Thus, as applied to a print mask, an interleaving mask indicates whether or not drops are to be deposited according to the print mask are actually deposited. This can be described as an interleaving mask removing drops to be deposited according to a print mask within the interleaving zone or selecting a subset of drop locations provided by the print mask.

Interleaving masks may be designed according to a profile. For example, an interleaving mask corresponding to a top interleaving zone may be designed according to a linear transition, such that the first row of the interleaving mask has a minimum drop density (e.g., 0%) and at the last row of the interleaving mask has a maximum drop density drops (e.g., 100%), where the drop density increases from the first row to the last row in a linear manner. That is, in one example, the first row of the interleaving mask may include all 0's, the last row of the interleaving mask may include all 1's, and rows in between the first and last row may include a number of 0's and 1's according to a linear transition. Thus, an interleaving mask may be based on an objective drop density for each row. Objective drop densities may be selected according to a function (e.g., linear, exponential, etc.) provided by a profile. In some examples, the interleaving mask corresponding to the bottom interleaving zone may be the complement of the top interleaving mask. That is, the bottom interleaving mask may have the opposite value of 0 or 1 at each location provided in the top interleaving mask.

FIG. 5 illustrates examples of interleaving masks and the result of applying interleaving masks to print masks according to some examples. In the example of FIG. 5, the interleaving mask corresponding to interleaving zone 0 has an increasing linear density from 0% to 100% (i.e., 0% 1's at row 1, 16.6% 1's at row 2, 33.3% 1's at row 3, 50% 1's at row 4, 66.6% 1's at row 5, and 100% 1's at row 6) and the interleaving mask corresponding to interleaving zone 1 is a complement of the interleaving mask corresponding to interleaving zone 0. As a result, the result of applying the interleaving mask according to interleaving zone 0 to the original print mask is drops corresponding to 9 of the 18 firing locations in the original print mask being fired at the bottom of a print swath. That is, interleaving masks may effectively select a certain subset of the original firing locations in a generated print mask to be moved from a top portion of a print swath to bottom portion of a print swath. Using interleaving masks may minimize artifacts due to media advance errors, may further reduce artifacts due to other errors, and/or may further improve grain characteristics.

In one example, interleaving unit 208 may generate interleaving masks independently for each pass. In the example illustrated in FIG. 5, the interleaving mask for interleaving zone 0 is designed based on the objective density for the row at the top (0%) and the objective density for the row at the bottom (100%). There may be several ways to design an interleaving mask according to the objective density for the row at the top and the objective density for the row at the bottom. For example, 1's could be randomly distributed in a row such that an objective density for a row is satisfied. For example, the 1 in the second row of the interleaving mask for interleaving zone 0 could be randomly placed in any of the six columns.

Further, according to the techniques herein, an interleaving mask may further be generated based on the homogeneity distributions of 1's and 0's. That is, as described above, it may be desirable to preserve uniform distribution within the varying linear density of an interleaving mask. Thus, the decision of putting a 0 or a 1 at a particular location in an interleaving mask may depend on the objective density for the row and also on a local density of drops. For example, if an objective density of a row is 50%, the local density of drops may be used to select how to position 1's at half the locations within the row.

For example, an original print mask may correspond to a pass of the print mask generated according to the examples described above with respect to FIG. 3B. That is, a halftone matrix may be generated according to a desired noise characteristic and the print mask may be optimized according to a uniform density. As illustrated in FIG. 5, the locations of the 1's in the interleaving mask for interleaving zone 0 in FIG. 5 are all at locations which are aligned with locations of 1's in the original print mask. Thus, in the case where each 1 in the print mask in FIG. 5 corresponds to a masked halftone pattern based on a halftone matrix which has a particular drop location density and the print mask has been optimized, aligning locations of 1's in the interleaving mask with locations of 1's in the original print mask, uses a local density of drops to select how to position 1's. Thus, in some examples, an interleaving mask may be based on an objective drop density for each row of the interleaving mask, local drop density provided by a halftone matrix, and/or drop locations provided by a print mask.

As such, as illustrated in FIG. 5, application of the interleaving mask for interleaving zone 0 in FIG. 5 results in a pattern of the prescribed varying density that looks homogeneous. Further, the interleaving mask for interleaving zone 1, which is a complement to the interleaving mask for interleaving zone 0, has the same qualities. For such a case, in designing interleaving masks, because the halftone matrix has been generated according to a desired noise characteristic and the print mask has been optimized according to a uniform density, it can be assumed that a wide range of NPac vectors will have a desirable appearance, even if the NPac vector is not considered. That is, in some examples, interleaving unit 208 may generate and/or select interleaving masks without directly considering a NPac vector, a halftone matrix, or a resulting halftone pattern. In some cases, for these examples, interleaving unit 208 may generate and/or select interleaving masks based on a print mask with (or without) an assumption that a halftone matrix and/or a print mask been generated according to a desired characteristic. For example, in some examples, interleaving unit 208 may assume that the halftone pattern has a desired blue noise characteristic.

As described above, in some examples, NPs can correspond to 0, 1, 2 or 3 drops (e.g., C, M, Y, CM, CY, MY, CMY, and W). As such, in some examples, a halftone pattern may indicate whether 0, 1, 2 or 3 drops are deposited to a location. In one example, given a printing mask for a certain number of passes P, interleaving unit 208 may build the corresponding interleaving masks (complementary top and bottom masks) for a certain pass p; 0≤p≤P−1. In one example, according to a target profile, there may be a list with the number of drops that for every row of the interleaving mask (e.g., 0 for the first row and a maximum number for the last row), which provides an objective drop density for each row. Interleaving unit 208 may build 2D Gaussian kernels with 0 means and standard deviations depending on the local densities per row of the status of the top and bottom interleaving masks. For every row, interleaving unit 208 may select a location in the top interleaving mask where a drop will be added and select a location in the bottom interleaving mask where a drop will be removed. In one example, interleaving unit 208 may perform convolution with a wrap-around method using the Gaussian kernels with the status of the top and bottom masks. This identifies voids and clusters according to the maximum or minimum values of the result of the convolutions. Thus, points may be moved from the clustered areas in the bottom interleaving mask. Areas with the biggest voids may be filled in the top interleaving mask. It should be noted that in general the best location to remove a drop from the bottom interleaving mask is not the best location to add a drop to the top interleaving mask. Thus, applying a weight function that depends on the local density may be used to evaluate the final selection.

Thus, in one example, interleaving unit 208 may generate a top and a complementary bottom interleaving mask according to a target profile specifying a number of drops per row, identify voids in the top interleaving mask, identify clusters in the bottom interleaving mask, and modify the top and bottom interleaving masks according to the identified voids and clusters. In one example, modifying the top and bottom interleaving masks includes changing a number of 0 values in the top interleaving mask to 1 and changing a corresponding number of 1 values in the bottom interleaving mask to 0. It should be noted that in some examples, density, voids, clusters may relate to the density after halftoning and masking for several monochrome uniform density inputs. Due to the characteristics of the halftoning and masking processes, the set of drops on a substrate for a higher density may be a superset of that at a lower density. Thus, interleaving masks can be built up by gradually increasing the density, assigning a 0 or a 1 to each drop occurring in the masked halftone for that density, and continuing this process until maximal density, (e.g. 3 drops per position) is reached.

It should be noted that modifying the top and bottom interleaving masks according to the identified voids and clusters may be useful for cases where a halftone pattern and or a print mask has not been optimized. That is, because interleaving unit 208 considers local density while generating the interleaving masks, the result of applying the interleaving mask to print masks results in a desirable spatial distribution of NPs. Thus, interleaving unit 208 may generate interleaving mask which provide improved characteristics regardless of a particular halftone and/or masking process.

FIG. 6 is a flowchart illustrating a process for causing colorant to be deposited to a substrate according to interleaving zones according to an example. In one example, the entirety, or aspects thereof, of process 600 may be performed by printer device 100 and/or controller 200. In one example, the entirety, or aspects thereof, of process 600 may be performed by a computing device in communication with printer device 100 and/or controller 200, for example, information pertaining to a treatment amount may be transmitted from a computing device to printer device 100.

Referring to FIG. 6, at 602, top and bottom interleaving zones of a print swath are defined. For example, controller 200 may define a top interleaving zone and a bottom interleaving zone, as described above. At 604, a top interleaving mask corresponding to the top interleaving zone based on an objective drop density for the top interleaving mask, and drop locations provided by a print mask is generated. At 606, a bottom interleaving mask corresponding to the bottom interleaving zone based on the top interleaving mask is generated. For example, interleaving masks may be generated as described above. At 608, a subset of drop locations provided by the print mask is selected by applying the top and bottom interleaving masks to the print mask. For example, interleaving masks may be applied to a print mask as described above. At 610, colorant is caused to be deposited to a substrate according to the selected subset of drop locations. For example, as described above, controller 200 may generate print data according to interleaving zones.

In this manner, printer device 100 and/or controller 200 represents a device to define top and bottom interleaving zones of a print swath, generate a top interleaving mask corresponding to the top interleaving zone based on an objective drop density for the top interleaving mask, and drop locations provided by a print mask, generate a bottom interleaving mask corresponding to the bottom interleaving zone based on the top interleaving mask, select a subset of drop locations provided by the print mask by applying the top and bottom interleaving masks to the print mask, and cause colorant to be deposited to a substrate according to the selected subset of drop locations.

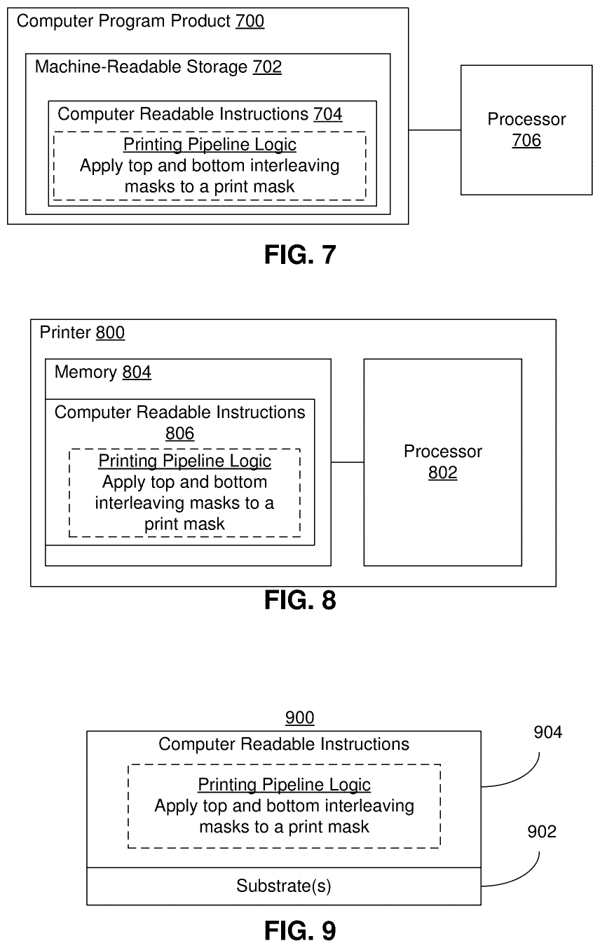

FIG. 7 illustrates a block diagram of an example computer program product 700. In some examples, as shown in FIG. 7, computer program product 700 includes a machine-readable storage 702 that may also include computer readable instructions 704. In some implementations, the machine-readable storage 702 may be implemented as a non-transitory machine-readable storage. In an example, the computer readable instructions 704 may be executed by a processor 706 and implement aspects of process 600, described above. That is, printing pipeline logic illustrated FIG. 7 may include aspects of process 600.

FIG. 8 is a block diagram illustrating a hardware apparatus including a semiconductor package according to an example. FIG. 8 shows an illustrative example of a printer 800. In the illustrated example, the printer 800 may include a processor 802 and a memory 804 communicatively coupled to the processor 802. The memory 804 may include computer readable instructions 806. In an example, the computer readable instructions 806, may be executed by the processor 802 and implement aspects of process 600, described above. That is, printing pipeline logic illustrated in FIG. 8 may include aspects of process 600.

In some implementations, the processor 802 may include a general purpose controller, a special purpose controller, a storage controller, a storage manager, a memory controller, a micro-controller, a general purpose processor, a special purpose processor, a central processor unit (CPU), the like, and/or combinations thereof. Further, implementations may include distributed processing, component/object distributed processing, parallel processing, the like, and/or combinations thereof. For example, virtual computer system processing may implement the methods or functionalities as described herein, and the processor 802 described herein may be used to support such virtual processing.

In some examples, memory 804 is an example of a computer-readable storage medium. For example, memory 804 may be any memory which is accessible to the processor 802, including, but not limited to RAM memory, registers, and register files, the like, and/or combinations thereof. References to “computer memory” or “memory” should be interpreted as possibly being multiple memories. The memory may for instance be multiple memories within the same computer system. The memory may also be multiple memories distributed amongst multiple computer systems or computing devices.

FIG. 9 shows an illustrative semiconductor apparatus 900 (e.g., chip and/or package). The illustrated apparatus 900 includes substrates 902 (e.g., silicon, sapphire, or gallium arsenide) and computer readable instructions 904 (such as, configurable computer readable instructions) and/or fixed-functionality computer readable instructions (e.g., hardware)) coupled to the substrate(s) 902. In an example, the computer readable instructions 904 implement aspects of process 600. That is, printing pipeline logic illustrated in FIG. 9 may include aspects of process 600.

In some implementations, computer readable instructions 904 may include transistor array and/or other integrated circuit/IC components. For example, configurable logic and/or fixed-functionality hardware logic implementations of the computer readable instructions 904 may include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

All definitions, as defined and used herein, should be understood to control over dictionary definitions, definitions in documents incorporated by reference, and/or ordinary meanings of the defined terms.

Furthermore, for ease of understanding, certain functional blocks may have been delineated as separate blocks; however, these separately delineated blocks should not necessarily be construed as being in the order as discussed or otherwise presented herein. For example, some blocks may be able to be performed in an alternative ordering, simultaneously, etc.

Although a number of illustrative examples are described herein, numerous other modifications and examples can be devised that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent. The examples may be combined to form additional examples.

What is claimed is:

1. A method comprising:
defining top and bottom interleaving zones of a print swath;
generating a top interleaving mask corresponding to the top interleaving zone based on an objective drop density for the top interleaving mask, and drop locations provided by a print mask;
generating a bottom interleaving mask corresponding to the bottom interleaving zone based on the top interleaving mask;
selecting a subset of drop locations provided by the print mask by applying the top and bottom interleaving masks to the print mask; and
causing colorant to be deposited to a substrate according to the selected subset of drop locations.

2. The method of claim 1, wherein generating the top interleaving mask includes:
determining a number of drops included in each row of the top interleaving mask based on the objective drop density for each row; and
determining locations of drops in each row of the top interleaving mask based on the halftone matrix, and the print mask.

3. The method of claim 1, wherein an objective drop density for the top interleaving mask provides an objective drop density for each row of the top interleaving mask increases from a minimum drop density at a top row of the top interleaving mask to a maximum drop density at a bottom row of the top interleaving mask.

4. The method of claim 3, wherein the objective drop density for each row of the top interleaving mask increase in a linear manner.

5. The method of claim 3, wherein the minimum drop density is 0% and the maximum drop density is 100%.

6. The method of claim 1, wherein generating a bottom interleaving mask corresponding to the bottom interleaving zone based on the top interleaving mask includes generating the bottom interleaving mask as a complement of the top interleaving mask.

7. A non-transitory computer-readable storage medium comprising a set of computer-readable instructions that, when executed by a processor, cause the processor to:
define top and bottom interleaving zones of a print swath;
generate a top interleaving mask corresponding to the top interleaving zone according to an objective density increasing linearly from a top row to a bottom row;
generate a bottom interleaving mask corresponding to the bottom interleaving zone, wherein the bottom interleaving mask is based on the top interleaving mask; and
apply the generated top interleaving mask and the generated bottom interleaving mask to a print mask corresponding to a printing pass.

8. The non-transitory computer-readable storage medium of claim 7, wherein objective densities for each row of the top interleaving mask increase linearly from a minimum drop density at a top row of the top interleaving mask to a maximum drop density at a bottom row of the top interleaving mask.

9. The non-transitory computer-readable storage medium of claim 7, wherein apply the generated top interleaving mask and the generated bottom interleaving mask to a print mask corresponding to a printing pass includes removing drops to be deposited according to the print mask within the interleaving zones.

10. The non-transitory computer-readable storage medium of claim 7, wherein the top interleaving zone and bottom interleaving zone cover approximately 20 percent of the print swath.

11. A printer comprising:
a memory; and
a processor to:
generate a top interleaving mask corresponding to a top interleaving zone of a print swath based on an objective drop density for each row of the top interleaving mask, local drop density provided by a halftone matrix, and drop locations provided by a print mask;
generate a bottom interleaving mask corresponding to a bottom interleaving zone of the print swath based on the top interleaving mask;
select a subset of drop locations provided by the print mask by applying the top and bottom interleaving masks to the print mask; and
cause colorant to be deposited to a substrate according to the selected subset of drop locations.

12. The printer of claim 11, wherein the top interleaving zone is aligned with a first row of the print mask and the bottom interleaving zone is aligned with a last row of the print mask.

13. The printer of claim 11, wherein the halftone matrix is generated according to a noise characteristic.

14. The printer of claim 13, wherein the halftone matrix is a blue noise halftone matrix.

15. The printer of claim 11, wherein generating an interleaving mask includes selecting an interleaving mask.
